(19) United States
(12) Patent Application Publication
(10) Pub. No.: US 2026/0244701 A1
(43) Pub. Date: Aug. 20, 2026

(54) METHOD FOR SOLVING A COMPUTATION PROBLEM

(71) Applicant: Kipu Quantum GmbH, Karlsruhe (DE)

(72) Inventors: Qi Zhang, Berlin (DE); Eric Michon, Berlin (DE); Narendra Narayana Hegade, Bengaluru (IN); Enrique Leonidas Solano Villanueva, Berlin (DE); Murilo Henrique De Oliveira, Berlin (DE)

(73) Assignee: Kipu Quantum GmbH, Karlsruhe (DE)

(21) Appl. No.: 19/161,996

(22) PCT Filed: Mar. 4, 2024
(86) PCT No.: PCT/EP2024/055637

§ 371 Date: Sep. 3, 2025

(30) Foreign Application Priority Data
Mar. 3, 2023 (EP) 23159923.4

(51) Int. Cl. G06F 17/11; G06N 10/20; G06N 10/40

(52) U.S. Cl. CPC G06F 17/11; G06N 10/20; G06N 10/40

(57) ABSTRACT

The invention relates to a computer-implemented method, to a computer program and to a computer device as described herein. In particular, the invention relates to a computer-implemented method for solving a computation problem, comprising the use of an Ising Hamiltonian in the form (I): wherein (II), Ω is the Rabi frequency of the transition and can be dynamically controlled by controlling the power of one of the coupling laser, Δ corresponds to the detuning with regards to the two-photon transition and can also easily be changed dynamically, and the term containing ∫ is the interactions term implemented via a Rydberg blockade mechanism and can optionally be rendered site-dependent or can be dynamically tuned, wherein the problem is solved by finding the ground state of the final Hamiltonian.

H_{Ryd}=Ω(t)Σᵢσᵢ^{x}−Δ(t)Σᵢnᵢ+JΣ_{i,j}nᵢnⱼ (I)

nᵢ=(1−σᵢ^{z})/2, (II)

### CROSS-REFERENCE TO RELATED APPLICATIONS

This application claims priority to European patent application 23159923.4, filed Mar. 3, 2023, the disclosures of which is incorporated by reference herein in its entirety.

### TECHNICAL FIELD

The invention relates to quantum computing. The invention relates to quantum computing. Certain embodiments are defined by the appended independent and dependent claims.

The invention also relates to a computer-implemented method for solving a computation problem such as a combinatorial optimization problem on a computer with neutral atoms or trapped ions. In particular embodiments, the method is based on analog counterdiabatic quantum computing (ACQC).

### SHORT DESCRIPTION OF THE INVENTION

The invention refers to a method that is a Floquet engineering analog counterdiabatic quantum computing (F-ACQC) method which is a computer-implemented method for solving a combinatorial optimization problem such as maximum independent set (MIS) problems, using an analog quantum computer.

The object of the present invention is to provide an improved means for solving a computation problem such as an optimization problem that is performed by a quantum computer.

This object is achieved by the invention.

In a first aspect, the invention refers to a method, in particular a computer-implemented method, for solving a combinatorial optimization problem.

A combinatorial optimization problem that may be solved with the present invention in particular embodiments is a mathematical problem where the idea is to find the parameters that minimize or maximize a given multivariable function, called the cost function. The combinatorial optimization problem may, for example, be a Maximum independent set (MIS) problem. Such a combinatorial optimization problem may be finding a lowest energy configuration of the atoms of a molecule.

The method of the invention uses an analog quantum computer with a central processing unit (CPU) and a quantum processing unit (QPU), for example as described with reference to FIG. 11.

In certain embodiments, the method comprises as number of steps.

In one step of the method, a first step may be providing to the quantum processing unit (QPU) of the analog quantum computer a time-dependent adiabatic Hamiltonian. The quantum computing process happens in an analog quantum computing system; a “quantum system” refers to a system described by a Hamiltonian. In the context of analog quantum computing, the quantum system is designed to perform computations using continuous-variable quantum states. To solve a problem on an analog quantum computer, computations are performed in a quantum system of the analog quantum computer.

In certain embodiments, the time-dependent adiabatic Hamiltonian contains a set of continuous quantum variables which are controllable on the analog quantum computer, and the ground state of the time-dependent adiabatic Hamiltonian at a final evolution time encodes the solution to the combinatorial optimization problem.

In certain embodiments, the method comprises the step of calculating nested commutator counterdiabatic (CD) terms as being an approximate adiabatic gauge potential of the time-dependent adiabatic Hamiltonian.

In particular, the nested commutator counterdiabatic (CD) terms each comprise quantum Pauli X-operators, Y-operators, and Z-operators and commutator counterdiabatic (CD) coefficients of these X-, the Y- and the Z-operators.

The nested commutator counterdiabatic term adds a gauge potential that counters excitations arising from the non-adiabatic evolution.

In certain embodiments, the method comprises the step of replacing the adiabatic Hamiltonian by a Floquet-Hamiltonian comprising a set of continuous quantum Floquet-variables.

In certain embodiments, the method comprises the step of calculating a set of continuous quantum Floquet-variables to provide a Floquet-Hamiltonian containing the set of continuous quantum Floquet-variables, and replacing the adiabatic Hamiltonian with the Floquet-Hamiltonian.

In certain embodiments, the method comprises the step of implementing the set of continuous quantum Floquet-variables on the quantum processing unit (QPU) of the analog quantum computer so that the analog quantum computer evolves with time in a counterdiabatic manner to reach the ground state of the Floquet-Hamiltonian.

In certain embodiments, the method comprises the step of measuring a quantum state of the analog quantum computer at the final evolution time to obtain a read-out of the quantum system.

In certain embodiments, the method comprises the step of determining a solution to the combinatorial optimization problem from the read-out.

In certain embodiments, the method comprises the step of calculating a set of continuous quantum Floquet-variables to provide a Floquet-Hamiltonian containing the set of continuous quantum Floquet-variables, and replacing the adiabatic Hamiltonian with the Floquet-Hamiltonian.

In certain embodiments of the method, the set of continuous quantum Floquet-variables is calculated by using a Floquet engineering method, in particular a Floquet engineering method comprising the steps of
(1) manipulating the time-dependent Floquet-Hamiltonian by applying a periodic driving forces protocol, such as a sinusoidal function, to create a periodic modulation of the time-dependent Hamiltonian which evolves the quantum system dynamically with time,
(2) decomposing the periodic (in particular sinusoidal) function into a sum of sine and/or cosine functions, each multiplied by a time-dependent coefficient, and
(3) solving the time-dependent coefficients of sine or cosine functions by satisfying the periodic modulation of the time-dependent Hamiltonian being the effective combination of the adiabatic Hamiltonian and its nested commutator CD Hamiltonian, wherein the coefficients are used to as the Floquet-variables.

In certain embodiments of the method of the invention, the Floquet-Hamiltonian mathematically is an approximation of the summation of the time-dependent adiabatic Hamiltonian and the nested commutator counterdiabatic (CD) terms.

In certain embodiments of the method of the invention, the evolution of the time-dependent Floquet-Hamiltonian from its initial computation time to the final computation time is performed using the Floquet engineering method to modulate a time dependent scheduling function.

In certain embodiments of the method of the invention, the modulation comprises at least one nested commutator counterdiabatic (CD) coefficient as part of a nested commutator counterdiabatic (CD) term.

In certain embodiments of the method of the invention, the nested commutator counterdiabatic (CD) term is

$${H}_{C D}^{( ℓ )} = i {\sum }_{k = 1}^{ℓ} {α}_{k} ( t ) {\underbrace{[ {H}_{ad} , [ {H}_{ad} , … [ {H}_{ad} , {\partial }_{t} {H}_{ad} ] ] ]}}_{2 k - 1}$$

wherein H_{ad} is the time-dependent adiabatic Hamiltonian, αₖ(t) is a nested commutator counterdiabatic (CD) coefficient.

In certain embodiments, H_{ad} is added into the quantum system by doing a summation of

$${H}_{ad} + {H}_{C D}^{( ℓ )}$$

to improve the adiabatic process using the Floquet engineering method to drive the quantum system of the analog quantum computer periodically, wherein the driving is described by

$${H}_{F} ( t ) = [ 1 + \frac{ω}{{ω}_{0}} cos ( ω t ) ] {H}_{ad} + β ( t ) {\partial }_{t} {H}_{ad}$$

(wherein ω is the frequency of the periodic driving, ω₀ is the natural frequency of the quantum system and β(t) is a time-dependent Floquet-coefficient) modulating the strength of a time derivative term of the adiabatic Hamiltonian in the periodic driving Hamiltonian H_{F}(t). In certain embodiments, the driving is calculated under the constraints of mimicking the nested commutator CD Hamiltonian

$${H}_{F} ( t ) \approx {H}_{ad} + {H}_{C D}^{( ℓ )} .$$

The analog quantum computer has neutral hardware in certain embodiments, such as neutral atoms (for example, Ground-Rydberg atoms) of trapped ions.

In cases where the analog quantum computer uses Ground-Rydberg atoms, the time-dependent adiabatic Hamiltonian may be an Ising Hamiltonian of the form

$${H}_{R y d} = Ω ( t ) {\sum }_{i} {σ}_{i}^{x} - Δ ( t ) {\sum }_{i} {n}_{i} + J {\sum }_{i , j} {n}_{i} {n}_{j}$$

wherein

$${n}_{i} = \frac{( 1 - {σ}_{i}^{z} )}{2} ,$$

where

$${σ}_{i}^{z}$$

is the Pauli Z matrix,
Ω is the Rabi frequency which describes the rate at which qubits transition between their two states when driven by an external oscillating field generated by a coupling laser, and is dynamically controlled by controlling the power of a coupling laser,
Δ corresponds to the detuning which represents the energy difference between the two states of the qubit with regards to a two-photon transition and is changed dynamically, and
the term containing J is the interactions term defined by a Rydberg blockade mechanism and is site-dependent or dynamically tuned.

In cases where the analog quantum computer uses trapped ions, the time-dependent adiabatic Hamiltonian may be

$${H}_{i o n s} ( t ) = {\sum }_{i} \frac{{Ω}_{i}}{2} ( {σ}_{i}^{x} cos {θ}_{i} + {σ}_{i}^{y} sin {θ}_{i} ) + {\sum }_{i < j} {J}_{i , j} {σ}_{i}^{x} {σ}_{j}^{x} ,$$

wherein Ωᵢ is resonant Raman Rabi frequency on ion i, θᵢ is angle of spin i in the xy plane of the Bloch sphere about the precession of an effective transverse magnetic field, and wherein they can be modulated through a coupling laser,
J_{i,j} is the effective spin-spin coupling strength between an ion I and an ion j which is defined as

$${J}_{i j} = {Ω}_{i} {Ω}_{j} {\sum }_{m} \frac{{η}_{i m} {η}_{j m}}{{δ}^{2} - {ω}_{m}^{2}} {ω}_{m}$$

wherein Ωᵢ are Rabi frequencies, δ is bichromatic detuning and ωₘ is mode frequency.

In certain embodiments of the method of the invention, the computation time is limited by a coherence time of the quantum system.

In a second aspect, the invention refers to a data processing apparatus (or a data processing device or a data processing system. Such an apparatus may comprise means for carrying out [the steps of] the method for solving a combinatorial optimization problem as described herein.

In certain embodiments the data processing apparatus has the form of an analog quantum computer on which the method for solving a combinatorial optimization problem as described herein.

The invention also refers to a method for solving a computation problem, in particular a combinatorial optimization problem, comprising the use of an Ising spin-glass Hamiltonian in the form

$${H}_{R y d} = Ω ( t ) {\sum }_{i} {σ}_{i}^{x} - Δ ( t ) {\sum }_{i} {n}_{i} + J {\sum }_{i , j} {n}_{i} {n}_{j} ,$$

wherein

$${n}_{i} = ( 1 - {σ}_{i}^{z} ) / 2 ,$$

Ω is the Rabi frequency of the transition and can be dynamically controlled by controlling the power of one of the coupling laser,
Δ corresponds to the detuning with regards to the two-photon transition and can also easily be changed dynamically, and
the term containing J is the interactions term implemented via a Rydberg blockade mechanism and can optionally be rendered site-dependent or can be dynamically tuned,
wherein the problem is solved by finding the solution for the Hamiltonian.

In a third aspect, the invention refers to a computer program [product] comprising instructions which, when the program is executed by a computer, cause the computer to carry out [the steps of] the method for solving a combinatorial optimization problem as described herein.

In a fourth aspect, the invention refers to a computer-readable [storage] medium comprising instructions which, when executed by a computer, cause the computer to carry out [the steps of] the method for solving a combinatorial optimization problem as described herein.

The invention also refers to a computer program having a program code for performing the method of one of the beforementioned claims, when the computer program is executed on a computer, a processor, a quantum-processing unit and/or a programmable hardware component.

The invention also refers to a computation device comprising: an interface for communicating with a quantum-processing unit; and one or more processors configured to perform the beforementioned method using the quantum-processing unit.

The invention also refers to the use of gGound-Rydberg qubits for quantum computation with neutral atoms or qubits with trapped ions, in particular in a method for solving a combinatorial optimization problem as described herein.

Other features and advantages of the invention will be apparent upon reading the detailed description and reviewing the accompanying drawings of the figures.

### DETAILED DESCRIPTION OF THE INVENTION

Various embodiments of the invention are further described in more detail with reference to the accompanying drawings. However, the invention may be embodied in many other forms and should not be construed as limited to any certain structure or function discussed in the following description.

According to the description, it will be apparent to the ones skilled in the art that the scope of the invention encompasses any embodiment thereof, which is disclosed herein, irrespective of whether this embodiment is implemented independently or in concert with any other embodiment of the invention. For example, the method disclosed herein may be implemented in practice by using any numbers of the embodiments provided herein. Furthermore, it will be understood that any embodiment of the invention may be implemented using one or more of the elements presented in the appended claims.

This invention relates to analog quantum computing. As input, a set of time-dependent scheduling functions is provided in certain embodiments which is used to control continuous quantum variables of quantum computers with time.

Digital quantum computing (DQC) is based on the application of sequences of single-qubit and multi-qubit gates. These operations are termed “digital blocks” and the protocol is known as a digital quantum algorithm. DQC is limited by the fact that it is resource-consuming and does not display robustness to errors in the computation. This makes DQC challenging to implement important and complex problems and reach quantum advantage. Analog quantum computing (AQC) involves platforms that can emulate the desired physical system as closely as possible by mimicking its dynamic and statistical properties. The aim is to design a simulator whose Hamiltonian can be engineered to match the properties of the target system. Such systems offer low errors and scalability.

There are several core principles that differentiate a classical computing system from a quantum computing system. The main one is that whilst classical computers utilize classical binary bits ‘0’ and ‘1’, quantum computing systems utilize states represented by a superposition of a plurality of orthogonal (and normalized) states. These orthogonal states are often called basis states. When limited to a two-level quantum system this state is called a qubit. Such quantum superpositions have no analogue in classical bits. The general pure qubit state |ψ> can be represented by: |ψ [symbol] =α|0 [symbol] +β|1

[symbol]

Alpha and beta are complex coefficients that are normalized such that alpha+beta=1 and |0> and |1> are the basis vectors (basis states) of the qubit. The classical 0 and 1 of conventional computers are special examples of qubits where alpha=1 and beta=0 for the measured state ‘0’ and where alpha=0 and beta=1 for the measured state ‘1’. Other qubits whose values of alpha and beta are greater than 0 and less than 1 give rise to quantum superposition whereby there is a finite chance to yield either state upon measurement.

The coefficients alpha and beta of the qubit are complex numbers and are more generally represented on a Bloch sphere and by equations (1) and (2) where e^{(iφ)} represents relative phase and global phase is represented by e^{(iγ)}. The classical states |0> and |1> are shown on the Bloch sphere as being the point where the sphere intersects the Z axis, wherein these classical states are also alternatively labelled by up and down arrows to accord with an alternative qubit nomenclature. For a pure qubit state |ψ(θ, φ) [symbol] ; θ and φ are the angles on the Bloch sphere representation wherein 0≤θ≤π and 0≤φ≤2π. The points on the surface of the Bloch sphere are pure states of the quantum system whilst interior points are mixed states. Equations (1) and (2):

$$α = {e}^{i γ} cos \frac{θ}{2} \qquad ( 1 )$$

$$β = {e}^{i ( γ + ϕ )} sin \frac{θ}{2} \qquad ( 2 )$$

A parametrized form of a qubit state is shown in Equation (3). Because the physics of quantum systems representing single qubits only considers relative phase, the coefficient of |0 [symbol] is real and non-negative so a qubit can be generally represented by equation (3):

$$\vert ψ 〉 = cos \frac{θ}{2} \vert 0 〉 + {e}^{i ϕ} sin \frac{θ}{2} \vert 1 〉 \qquad ( 3 )$$

Therefore, for example, as described above, a qubit state with a 100% probability of measuring the state of 1 has Θ=π, hence a coefficient β of 1 and a coefficient α of 0. Such a qubit state is equivalent to a classical computing state of 1. However, a qubit state with a 50% chance of being in either basis state 0 or 1, when measured and assuming no relative phase, may have pre-measurement qubit coefficients defined by Equation 4:

$$α = β = \frac{1}{\sqrt{2}} ( i . e . , {α}^{2} = {β}^{2} = 1 / 2 ) \qquad ( 4 )$$

In the Bloch sphere representation, a state stays in this superposition until either a measurement is made on the qubit, which collapses the qubit into the classical regime, or an operation is applied to the qubit to change its projection on the Bloch sphere. Until the qubit is measured it exists in all states permitted by the qubit superposition. Indeed, qubits that represent different states in the quantum realm may yield the same physical value when measured. However, when in a superposition state (pre-measurement) the different phases of the qubits may be utilized in the quantum circuit to effect different operations.

Several approaches for realizing quantum computation are being investigated in the field, both in terms of the computing technique and the technologies required to implement them. There are a number of different hardware platforms currently being developed to implement quantum computers. Technologies being utilized include ion traps, superconducting qubits, atomic-scale solid-state defects, neutral atoms and photonics.

In classical computers, a bit is physically represented by the voltage across a semiconductor transistor. In quantum computers, qubits are implemented using two level quantum states, which are specific to the exact implementation and physical system being used. Examples of quantum states for fermions are the spin up and spin down of an electron or the hyperfine states of atomic energy levels.

Quantum computing is a framework for computation, which aims at outperforming classical computation by exploiting quantum mechanical phenomena. Analog quantum computing refers to a method of quantum computation that utilizes continuous variables or properties of quantum systems to perform computations. In contrast to digital quantum computing, which uses discrete quantum qubits to encode information, analog quantum computing often involves manipulating continuous quantum variables, for example, the position and momentum of particles, the control field amplitudes and phase of quantum states in quantum systems. This approach aims to perform computations by directly encoding and processing information using the continuous properties of quantum systems. These systems can represent and manipulate information using the continuous properties of quantum states, potentially offering advantages in certain computational tasks compared to digital quantum computing. A good analog quantum computing algorithm is to provide well-designed functions for the continuous control variables of the corresponding time-dependent Hamiltonian of analog quantum computers during the initial computation time t=0 until the final time t=T so that the quantum computing system evolves towards the ground state of this time-dependent Hamiltonian at the computation time t=T which is the target final state. Finally, the optimization problem is solved when the quantum system reaches the target ground state since the ground state at the final time t=T, as the ground state at this stage encodes the solution to the optimization problem.

In analog quantum computing, the concept of a qubit, as traditionally understood in digital quantum computing, is somewhat different due to the continuous-variable nature of analog quantum systems. In analog quantum computing, qubits are not discrete entities like in digital quantum computing. Instead, continuous-variable quantum systems are utilized, and the basic unit of information is often represented by continuous quantum variables such as the position, momentum, or field amplitudes of the quantum system. These continuous variables serve as the analog counterpart to the qubit. For instance, in systems that utilize continuous-variable quantum states, properties such as the continuous amplitudes of light or the continuous degrees of freedom of quantum harmonic oscillators can be manipulated and processed to perform computations. These continuous variables play a role analogous to qubits in digital quantum computing.

Moreover, in analog quantum computing, the time evolution of qubits or continuous variables is typically described by quantum mechanical operators and equations, and it can be visualized by considering how these continuous variables change and interact with each other over time. The time evolution of quantum states under a Hamiltonian operator involves the use of quantum dynamics governed by Hamiltonians. It is described by the Schrödinger equation which is a fundamental equation in quantum mechanics. For continuous-variable systems, this equation might involve operators corresponding to position, momentum, or other continuous variables representing the system. For example, in systems involving continuous-variable quantum optics or harmonic oscillators, the evolution of field amplitudes or modes might be described by differential equations representing the dynamics of these variables under specific Hamiltonians.

In digital quantum computing, quantum gates are fundamental operations that manipulate qubits by performing specific transformations on their quantum states. These gates are crucial for performing computations and implementing quantum algorithms. However, in analog quantum computing, the operations and transformations are not discretely applied gates as in digital quantum computing. Instead of discrete quantum gates acting on individual qubits, analog quantum computing typically involves continuous operations and transformations on the continuous variables that represent the quantum states. These operations are more akin to continuous transformations, such as squeezing, displacing, or evolving the continuous properties of the quantum system over time using Hamiltonians or continuous-variable operations.

The handling and manipulation of these continuous quantum variables in analog quantum computing are different from the discrete operations performed on qubits in digital quantum computation. Analog quantum computing harnesses continuous variables, offering natural handling of continuous data and precision in computations. It holds promise for efficient quantum simulation, potential error resilience, resource efficiency in certain computational tasks, high-precision measurements in sensing and metrology, and diversification of algorithms for specific computational problems. However, it is an evolving field facing challenges like error correction and scalability, with researchers working to unlock its full potential compared to digital quantum computing.

In general, while the concept of gates as discrete operations on qubits is not directly applicable in analog quantum computing, there are analogs in the form of continuous operations or transformations that affect the continuous variables characterizing a quantum system's state.

These continuous transformations play a role in manipulating and evolving the quantum information encoded in the continuous-variable quantum systems, enabling computation in an analog context. Furthermore, the implementations of analog quantum computing vary between different quantum computer architectures.

Adiabatic quantum computing is based on slowly varying a quantum system's Hamiltonian so that its ground state evolves to represent the solution to a particular problem. For analog quantum computing, adiabatic quantum computing is a common method which is to choose the values of adiabatic control functions to be the values of continuous variables where this Hamiltonian is named adiabatic Hamiltonian. In another words, adiabatic quantum computing is to use an adiabatic Hamiltonian to govern the quantum dynamics of the quantum analog computing system where the adiabatic Hamiltonian is controlled by the continuous quantum variables with time. Therefore, the time evolution of quantum state under this adiabatic Hamiltonian evolves adiabatically towards a final state which is the quantum state of the system at the end of computation time t=T. If the quantum computer's computation time is as slow as possible, the final state will be the ground state of the adiabatic Hamiltonian at the final time which encodes the solution to the combinatorial optimization problem, and the problem is solved. However, the adiabatic quantum computing requirements are experimentally hard to fulfill which reduces the probability of successfully solving the problem at the final computation time (success probability) on the hardware or which requires long computation time to solve the problem and it may longer than the hardware limitation. Therefore, this invention provides a new method to improve the quality of solving this optimization problem faster and better.

In a first aspect, the invention pertains to a method, in particular to a computer-implemented method for solving a combinatorial optimization problem using an analog quantum computer with a central processing unit (CPU).

In certain embodiments, the method comprises the following steps:
1) Providing to the quantum processing unit (QPU) of the analog quantum computer a time-dependent adiabatic Hamiltonian,
   wherein the time-dependent adiabatic Hamiltonian contains a set of continuous quantum variables which are controllable on the analog quantum computer, and
   wherein the ground state of the time-dependent adiabatic Hamiltonian at a final evolution time encodes the solution to the combinatorial optimization problem;
2) Calculating nested commutator counterdiabatic (CD) terms as being an approximate adiabatic gauge potential of the time-dependent adiabatic Hamiltonian,
   wherein the nested commutator counterdiabatic (CD) terms comprise quantum Pauli X-operators, Y-operators, and Z-operators and commutator counterdiabatic (CD) coefficients of the X-, the Y- and the Z-operators;
3) Replacing the adiabatic Hamiltonian by a Floquet-Hamiltonian comprising a set of continuous quantum Floquet-variables;
4) Implementing the set of continuous quantum Floquet-variables on the quantum processing unit (QPU) of the analog quantum computer so that the analog quantum computer evolves with time in a counterdiabatic manner to reach the ground state of the Floquet-Hamiltonian;
5) Measuring a quantum state of the analog quantum computer at the final evolution time to obtain a read-out of the quantum system; and
6) Determining a solution to the combinatorial optimization problem from the read-out.

Step 1: The invention is performed using a quantum processing unit (QPU) of an analog quantum computer.

A combinatorial optimization problem is an optimization that deals with problems where the goal is to find the best solution among a finite set of possible solutions. Usually, combinatorial optimization problems are based on trying to minimize a cost function written as

$$C = - {\sum }_{i}^{N} {Z}_{i} + {\sum }_{i , j}^{N} {Z}_{i} {Z}_{j} .$$

Maximum independent set (MIS) is a kind of a combinatorial optimization problem consisting of a graph of vertices connected by edges and for which the solution is the graph containing the maximum number of colored vertices without having two colored vertices connected by an edge. The MIS problem has applications across various fields, demonstrating its importance in solving real-world problems. For example, the graph coloring problems, social network analysis to identify communities, detect influential nodes, and recommend connections, telecommunications to design and optimize communication networks, transportation and logistics to optimize route planning, vehicle scheduling, and transportation network systems, bioinformatics to analyze biological networks, protein-protein interaction, and identify genetic relationships. In chemistry, the MIS can be used, for example, in the analysis of molecular structures. For instance, in the study of chemical compounds, the vertices can represent atoms, and edges can represent chemical bonds. Finding an MIS in such a graph can help identify sets of atoms that are not directly bonded to each other, which might correspond to potential sites for chemical reactions or the identification of stable configurations that do not share direct bonds.

A time-dependent adiabatic Hamiltonian is characterized by a Hamiltonian H(t) which dynamically changes with time, and the change is adiabatic so that the quantum state during the evolution time stays at the ground state without exciting to the higher energy states.

The time-dependent adiabatic Hamiltonian contains a set of continuous quantum variables which are controllable on the analog quantum computer. The set of continuous quantum variables comprises all of the adiabatic time-dependent parameters which fulfill the conditions at initial time and final time of the computation so that the quantum variables change with time adiabatically. On the analog quantum computer, the set of variables can be dynamically controlled by manipulating the external field or control signals of qubits of the analog quantum computer.

The ground state of the time-dependent adiabatic Hamiltonian at a final evolution time encodes the solution to the combinatorial optimization problem.

In certain embodiments, the adiabatic evolution is performed using a quantum annealer.

Quantum annealing is a computational method used to find low-energy states, especially the ground state, of discrete systems like combinatorial optimization problems. It is akin to classical annealing but employs quantum effects, such as quantum tunneling, to potentially reach a global energy minimum more accurately and quickly. While thermal effects and noise can assist in quantum annealing, the final low-energy state may not always be the global minimum. Adiabatic quantum computation is a specialized form of quantum annealing where the system ideally stays in its ground state throughout the process. Quantum annealing methods can generally be implemented on an adiabatic quantum computer.

Quantum annealing starts from a superposition of states (candidate states). As time progresses, the system evolves following the time-dependent Schrödinger equation, where the Hamiltonian is transformed into the one that encodes the solution of the problem Hₚ. If the change of the control field is slow enough, the system stays close to the ground state of the instantaneous Hamiltonian. At the end of the annealing process, the quantum system is measured, collapsing the qubits into a specific state which represents a potential solution to the problem.

The framework used to compute problems onto an analog quantum computer is the adiabatic computing and quantum annealing. At the start of the process, in certain embodiments, the Hamiltonian is set up so that the qubits can be prepared in a known state, often referred to as the initial state (e.g., all qubits in the |0 [symbol] state) and evolves the system towards a final Hamiltonian which has the solution of the computation problem as its ground state. For adiabatic quantum computing, the evolution should be slow enough which yields very long computation times. This is limited by the coherence time of the system which does not allow complete adiabatic evolution. In the case of neutral hardware, the computation of solving combinatorial optimization problems can only be done with a non-adiabatic evolution. This leads to possible excitations in the energy spectrum and can yield the wrong final state, in other words the wrong solution to the problem. To circumvent that one can try optimizing the time dependent functions of the control fields with which the system evolves into the final Hamiltonian. These functions are called the scheduling functions. In certain embodiments, quantum annealing involves tuning parameters such as the annealing schedule and qubit couplings to match the problem's characteristics by manipulating the external field or control signals of qubits of the analog quantum computer being values of scheduling functions during the computation time.

An appropriate quantum annealer for solving the problem configured to produce a desired final Hamiltonian (problem Hamiltonian, which is a time-dependent adiabatic Hamiltonian at the final time of the computation) comprises tunable scheduling functions. The quantum annealer may comprise at least one scheduling function that is a time-dependent tunable parameter of the used hardware.

The parametrization of at least one given scheduling function into tunable parameters leads to the fixation of random initial values for each parameter, and the fixation of the running time (according to the coherence time) of the quantum processor that is used in the method.

Any arbitrary time-dependent scheduling function is a general solution of choosing a scheduling function, without the idea of optimization. The time-dependent scheduling function can be (1) any arbitrary function which only needs to fulfill the initial (t=0) and final (t=T) boundary conditions; and (2) accessible to be a smooth time-dependent function (for example avoiding a sudden dump during the time evolution).

In certain embodiments, the computer-implemented method for solving a combinatorial optimization problem, comprises the use of an Ising Hamiltonian in the form

$${H}_{R y d} = Ω ( t ) {\sum }_{i} {σ}_{i}^{x} - Δ ( t ) {\sum }_{i} {n}_{i} + J {\sum }_{i , j} {n}_{i} {n}_{j} \qquad ( 5 )$$

wherein

$${n}_{i} = ( 1 - {σ}_{i}^{z} ) / 2 , Ω ( t )$$

frequency of the transition and can be dynamically controlled by controlling the power of one of the coupling lasers (the function of the laser is to start a transition between qubit states), Δ(t) corresponds to the detuning with regards to the two-photon transition and can also easily be changed dynamically, and the term containing J is the interactions term implemented via a Rydberg blockade mechanism and can optionally be rendered site-dependent or can be dynamically tuned, wherein the problem is solved by finding the ground state of the final Hamiltonian.

In particular, adiabatic computing and quantum annealing is performed.

The final evolution time is reached when measure the quantum state of the quantum computing system.

The term “analog quantum computing system” refers to the quantum system of the analog quantum computer's quantum processing unit.

Step 2: Calculating nested commutator counterdiabatic (CD) terms as being an approximate adiabatic gauge potential of the time-dependent adiabatic Hamiltonian.

Nested commutator counterdiabatic (CD) terms of an adiabatic Hamiltonian H_{ad} are defined as

$${H}_{CD}^{( ℓ )} = i {\sum }_{k = 1}^{ℓ} {α}_{k} ( t ) {\underbrace{[ {H}_{ad} , [ {H}_{ad} , … [ {H}_{ad} , {\partial }_{t} {H}_{ad} ] ] ]}}_{2 k - 1}$$

where H_{ad} is the adiabatic Hamiltonian.

The calculation of nested commutator counterdiabatic (CD) terms of the adiabatic Hamiltonian is performed by minimizing

$${S}_{ℓ} = T r [ {G}_{ℓ}^{2} ]$$

where

$${G}_{ℓ} = {\partial }_{t} {H}_{a d} - i [ {H}_{ad} , {H}_{C D}^{( ℓ )} ] .$$

Step 3: Calculating a set of continuous quantum Floquet-variables to provide a Floquet-Hamiltonian containing the set of continuous quantum Floquet-variables, and replacing the adiabatic Hamiltonian with the Floquet-Hamiltonian.

Floquet-Hamiltonian is defined as

$${H}_{F} ( t ) = [ 1 + \frac{ω}{{ω}_{0}} cos ( ω t ) ] {H}_{ad} + β ( t ) {\partial }_{t} {H}_{ad}$$

and β(t) is the continuous quantum Floquet-variable which is defined as

$$β ( t ) = {\sum }_{k = 1}^{∞} {β}_{k} sin ( ( 2 k - 1 ) ω t )$$

They are obtained from/by selecting a periodic driving forces protocol, such as a sinusoidal function which comprising a set of continuous quantum Floquet-variables.

The calculation of the set of continuous quantum Floquet-variables is performed by satisfying the constraints

$${H}_{F} ( t ) \approx {H}_{ad} + {H}_{C D}^{( ℓ )} .$$

Step 4: Implementing the set of continuous quantum Floquet-variables on the quantum processing unit (QPU) of the analog quantum computer so that the analog quantum computer evolves with time in a counterdiabatic manner to reach the ground state of the Floquet-Hamiltonian;

The term implementation refers to use the Floquet-Hamiltonian to replace the adiabatic Hamiltonian for the quantum computing process.

The ground state of the Floquet-Hamiltonian is reached when the quantum system is at the end of computation process by applying the periodic driving forces which can create a periodic modulation of the time-dependent Hamiltonian of the system to be a counterdiabatic process, so that the quantum system evolves dynamically with time.

Step 5: Measuring a quantum state of the analog quantum computer at the final evolution time to obtain a read-out of the quantum system.

The ground state of the Floquet-Hamiltonian (which is not adiabatic) is obtained by measuring the quantum state of the computing system at the end of computation.

Step 6: Determining a solution to the combinatorial optimization problem from the read-out.

Hardware: One hardware solution to implementing a quantum computer is the neutral atom system. In this system a plurality of atoms are spatially separated from each other and, each held in a different position about a spatial extent, often forming a spatial array. The atoms are close enough to each other such that entanglement operations are possible. Input signals are used to control the quantum state of atoms.

Another hardware solution to implementing a quantum computer is the trapped ion system. In this system a plurality of ions are spatially separated from each other using electromagnetic fields and, each held in a different position about a spatial extent, often forming a spatial array. The ions are close enough to each other to interact via their mutual Coulomb repulsion and shared motional modes such that entanglement operations are possible. External control signals in the form of microwave lasers are used to manipulate the quantum states of the ions and implement quantum gates.

In neutral atoms quantum computers and trapped ions quantum computers, the time taken to complete the computation is critical to the success of the computation. This is due to the decoherence of the quantum states over time. The control signals used to control the quantum computers are typically required to have some form of sequence, particularly when used to form quantum gates. The control signals are typically used to drive one or more lasers to output light pulses. Pulse sequences to implement a succession of quantum logic gates, in the prior art, are serial in manner; in other words, all the pulses for generating a first gate are output before the pulses are output for the second gate that follows that first gate. Such a sequence of control signals may result in a long computation time, particularly for a long sequence of gates, hence increasing the risk of the quantum system being adversely affected by decoherence.

The method of the present invention can be used on quantum computers with neutral atoms, or trapped ions.

For analog quantum computer with Ground-Rydberg atoms, the time-dependent adiabatic Hamiltonian is an Ising Hamiltonian of the form

$${H}_{Ryd} = Ω ( t ) {\sum }_{i} {σ}_{i}^{x} - Δ ( t ) {\sum }_{i} {n}_{i} + J {\sum }_{i , j} {n}_{i} {n}_{j} \qquad ( 6 )$$

wherein

$${n}_{i} = \frac{( 1 - {σ}_{i}^{z} )}{2} ,$$

where

$${σ}_{i}^{z}$$

is the Pauli Z matrix,
Ω is the Rabi frequency which describes the rate at which qubits transition between their two states when driven by an external oscillating field generated by a coupling laser, and is dynamically controlled by controlling the power of a coupling laser,
Δ corresponds to the detuning which represents the energy difference between the two states of the qubit with regards to a two-photon transition and is changed dynamically, and
the term containing J is the interactions term defined by a Rydberg blockade mechanism and is site-dependent or dynamically tuned.

For analog quantum computer with trapped ions, under the rotating wave approximation, an effective Ising Hamiltonian can be written as

$${H}_{i o n s} ( t ) = {\sum }_{i} \frac{{Ω}_{i}}{2} ( {σ}_{i}^{x} cos {θ}_{i} + {σ}_{i}^{y} sin {θ}_{i} ) + {\sum }_{i < j} {J}_{i , j} {σ}_{i}^{x} {σ}_{j}^{x} , \qquad ( 7 )$$

where Ωᵢ is the resonant Raman Rabi frequency on ion i, θᵢ is the angle of spin i in the xy plane of the Bloch sphere about the precession of an effective transverse magnetic field, and in principle, they can be modulated through the addressing lasers. J_{i,j} is the effective spin-spin coupling strength between an ion I and an ion j which can be defined as:

$${J}_{i j} = {Ω}_{i} {Ω}_{j} {\sum }_{m} \frac{{η}_{im} {η}_{j m}}{{δ}^{2} - {ω}_{m}^{2}} {ω}_{m} , \qquad ( 8 )$$

where the Ωᵢ are the Rabi frequencies, δ is the bichromatic detuning and ωₘ is the mode frequency.

Quantum optimization algorithms are quantum algorithms that are used to solve optimization problems.

In certain embodiments, the method of the invention is based on the implementation of a Floquet engineered nested commutator counterdiabatic protocol (F-ACQC) on an analog quantum hardware which is performed in neutral hardware using neutral atoms with ground-Rydberg qubits to solve combinatorial optimization problems. F-ACQC is to firstly calculate nested commutator CD terms which represent an approximate adiabatic gauge potential of a Hamiltonian to the quantum computing system. Since the current commercial neutral atom hardware does not allow to add arbitrary potentials, therefore, the next step is to implement this additional CD potential through a Floquet engineering method to mimic the approximate adiabatic gauge potential by manipulating continuous variables of the external field or control signal of the hardware that drives the quantum system. The continuous variables of the external field or control signal of the hardware can be, for example, the interaction between neutral atoms and at least one coupling laser involving using laser beams to trap, cool, manipulate, and control neutral atoms. Compared with the method without counterdiabatic protocol, this method solves the optimization problems faster with better quality of the results.

Optimization algorithms may also include algorithms performed by a quantum computer, such as quantum annealing, quantum approximate optimization algorithm (QAOA) or other noisy intermediate-scale quantum (NISQ) algorithms, quantum implemented fault-tolerant optimization methods, or other quantum optimization algorithms.

The final Hamiltonian (also referred to here as problem Hamiltonian and is a time-dependent adiabatic Hamiltonian at the final time of the computation) is the Hamiltonian that is addressing a time t=T which is the final time of the process in adiabatic quantum computing, quantum annealing, and by quantum annealers. The ground state of this Hamiltonian codifies the solution of a considered problem such as an optimization problem.

An expectation value is the mean value obtained after an experimental measure of a physical quantity several times in a quantum experiment.

A quantum processor is a programable quantum device composed of several informational units (qubits) that can be tuned in order to perform quantum algorithms.

In certain embodiments, the invention is used in chemistry to solve optimization problems. Such chemical optimization problems may be optimization problems for finding the ground state (the lowest energy state) of a chemical molecule.

Tunable parameters of the schedule functions may be the coupling laser power, the coupling laser phase, the coupling laser wavelength.

In particular, the preferred evolution is adiabatic which means that the evolution should be as slow as possible. However, the computation time is limited by the coherence time of the system which does not allow complete adiabatic evolution. The coherence time is related to the lifetime of the Rydberg state used for the computation.

In certain embodiments of the method of the invention, the computation of combinatorial optimization is performed in neutral hardware using neutral atoms.

In certain embodiments of the method of the invention, the time-dependent scheduling function with which the system changes from the initial Hamiltonian to the problem Hamiltonian comprises at least one nested commutator counterdiabatic (CD) term for adding an - approximate gauge potential that counters the excitations arising from the non-adiabatic time evolution.

Both alternatives are part of the invention for implementing the CD term: Floquet engineered nested commutator and a one-body CD term.

In certain embodiments of the method of the invention, at least one nested commutator CD term is created.

In certain embodiments of the method of the invention, the at least one nested commutator CD term is created by driving the system periodically with the variables of the total driving having been calculated under the constraints of mimicking the nested commutator CD Hamiltonian.

In certain embodiments of the method of the invention, the neutral hardware is chosen from the group consisting of neutral atoms or trapped ions.

In another aspect, the invention refers to the application of the method described herein in quantum chemistry, quantum finance, or quantum machine learning.

In another aspect, the invention refers to a system for performing a method described herein, comprising
a quantum processor, and
a memory to save the results of the measurements of expectation values of a final Hamiltonian.

In another aspect, the invention refers to a computer program having a program code for performing the method as described herein, when the computer program is executed on a computer, a processor, a quantum processor and/or a programmable hardware component.

In another aspect, the invention refers to a computation device comprising: an interface for communicating with a quantum-processing unit; and one or more processors configured to perform the method described herein using the quantum processor.

In another aspect, the invention refers to a use of a Rydberg state for quantum computation with neutral atoms.

In another embodiment, the invention refers to a method, in particular a computer-implemented method, for solving an optimization problem, comprising the step of
providing a quantum processor with tunable or untunable coupling for encoding an optimization problem.

Quantum computers (quantum processors) may include quantum annealing processors, digitized quantum processors, gate-based processors, or adiabatic quantum computation.

In certain embodiments, the invention refers to a method for solving a considered problem, comprising the step of:
Using an arbitrary number of qubits in a quantum processor device with tunable or untunable coupling for adiabatically encoding a considered problem, in particular wherein a time dependent Hamiltonian which at time zero is given by an initial Hamiltonian is at a final time given by the final or problem Hamiltonian.

An arbitrary number of qubits refers to any integer value of qubits. The minimum number of qubits is 1. In certain embodiments, the number of qubits is between 1 and 1000. In other embodiments, the number of qubits may be between 1 and 100.

In another aspect, the invention refers to a system comprising
a quantum processor with tunable or untunable coupling and free energies,
a memory to save the results of the measurements of the final Hamiltonian expectation values.

In another aspect, the invention refers to a use of the method described herein in quantum chemistry, quantum finance, or quantum machine learning.

In another aspect, the invention refers to a computer program having a program code for performing the method described herein, when the computer program is executed on a computer, a processor, a quantum-processing unit and/or a programmable hardware component.

In another aspect, the invention refers to a computation device comprising: an interface for communicating with a quantum-processing unit; and one or more processors configured to perform the beforementioned method using the quantum-processing unit.

In another aspect, the invention relates to a data processing apparatus/device/system comprising means for carrying out the method of the invention as described herein.

In particular, the invention relates to a system for performing the method of the invention as described herein, comprising
a quantum processor with tunable or untunable coupling,
a memory to save the results of the measurements of expectation values of a final Hamiltonian.

In another embodiment, the invention refers to a method, in particular a computer-implemented method, for solving an optimization problem, wherein the optimization algorithm is a constrained algorithm configured to avoid that the updated parameters surpass the experimental capabilities of the quantum device.

In another aspect, the invention refers to a system comprising
a quantum processor with tunable coupling and free energies,
a memory to save the results of the measurements of the final Hamiltonian expectation values, and
a classical processor to perform the classical optimization.

There is also presented a non-transitory computer readable medium comprising instructions for executing any one or more of the methods described in the first aspect. The method of the first aspect may be a computer implemented method.

There is also presented a system comprising an electronic computer comprising:
I) a processor; and
II) memory comprising instructions for executing the method as described in the first aspect.

The system may further comprise the neutral atom quantum computer. The system may comprise a chamber comprising the plurality of atoms. The system may comprise the plurality of electromagnetic sources.

The system may further comprise one or more further electromagnetic sources for:
I) trapping the atoms and/or ions; and/or
II) moving trapped atoms and/or ions.

The system may comprise one or more detectors for monitoring electromagnetic (EM) radiation output by the plurality of atoms. The one or more detectors may comprise a camera. The camera may be configured to detect fluorescent light emitted by the atoms and/or ions.

The system may be configured to hold atoms in an array of atom traps. The array may be 1D, 2D or 3D and may be periodic.

There is also presented a method of executing a quantum algorithm on a neutral atom quantum computer, the algorithm comprising the gate sequence. The method of executing a quantum algorithm comprises the method of the first aspect. The method of executing a quantum algorithm may further comprise trapping a plurality of the atoms. The method of executing a quantum algorithm may further comprise moving trapped atoms into a register. The method of executing a quantum algorithm may further comprise determining a result of the algorithm by analyzing data output from a detector monitoring EM radiation output by the atoms.

In another aspect, the invention refers to a use of the method described herein to solve combinatorial optimization problems in general that can be applied to solve specific problems such as the MIS that has applications in graph coloring, quantum chemistry, finance, or quantum machine learning.

In another aspect, the invention refers to a computer program having a program code for performing the method of one of the beforementioned claims, when the computer program is executed on a computer, a processor, a quantum-processing unit and/or a programmable hardware component.

In another aspect, the invention refers to a computation device comprising: an interface for communicating with a quantum-processing unit; and one or more processors configured to perform the beforementioned method using the quantum-processing unit.

In another aspect, the invention relates to a computer program (product) comprising instructions which, when the program is executed by a computer, cause the computer to carry out the method of the invention as described herein.

In another aspect, the invention relates to a computer-readable data carrier having stored thereon said computer program (product).

### FIGURES

The figures show:

FIG. 1 An example of a three-qubits-graph. The ideal ground state |101 [symbol] of the final Hamiltonian H_{Ryd}(T) encodes a combinatorial optimization problem in the form of a Maximal Independent Set (MIS) solution of this graph problem.

FIG. 2: The control field of a three-qubits-Hamiltonian in Eq. (15, 16, 18) by taking the example of scheduling functions in Eq. (24, 26). Parameters are Ω₀=1, Δ₀=5, J=4, ω₀=10, and ω=5ω₀.

FIG. 3: As an example of a three-qubits-graph problem in FIG. 1, the ideal ground state of the final Hamiltonian H_{Ryd}(T) is |101 [symbol] . In the case of initial state is the ground state of

$${H}_{Ryd} ( 0 ) = {Ω}_{0} {\sum }_{i} {σ}_{i}^{x} + J ( {n}_{1} {n}_{2} + {n}_{2} {n}_{3} ) ,$$

the success probability of the F-ACQC with time-dependent interactions protocol is compared with its corresponding Nested commutator CD method and adiabatic protocol (without CD). Parameters are Ω₀=1, Δ₀=6, J=4, ω₀=10π, and ω=10ω₀.

FIG. 4: The success probability as a function of total processing time T of a 3 qubits example in FIG. 1. The comparison is between (1) adiabatic protocol (dotted line), nested commutator CD protocol (dashed line) and Floquet-ACQC with constant interaction terms in Eq. (18) protocol (solid line). Parameters are the same as in FIG. 2.

FIG. 5: The population at final time for a 3 qubits example in FIG. 1 which is one case of FIG. 4 for T×Ω₀=0.7.

FIG. 6: An example of a 7 qubits graph. The MIS solution is shown to be |0100111 [symbol] .

FIG. 7: The success probability as a function of total processing time T of a 7 qubits example in FIG. 6. The comparison is between (1) adiabatic process (without CD, line with diamonds), nested commutator CD protocol (line with squares) and Floquet-ACQC with a time-dependent interaction terms in Eq. (17) protocol (line with circles). Parameters are Ω₀=1, Δ₀=6, J=4, ω/ω₀=10.

FIG. 8: The instantaneous control functions in Eq. (29, 30) for solving a 3-qubit graph problem in FIG. 1 for the case of the initial state is the ground state of Rydberg atoms |0 [symbol] ^{⊗N} (N is the number of qubits). Parameters are T=1 μs, Ω₀=2.5×2π MHz, Δ₀=9×2π MHz, J=55 MHz, ω₀=5Ω₀, and ω=1.5ω₀.

FIG. 9: The population under the control functions in FIG. 8. Parameters are the same as in FIG. 8.

FIG. 10: The flowchart of certain embodiments of the invention (Floquet-ACQC framework) illustrating the steps. Initially, the data from an adjacency matrix serves as the input which can be mapped to a Rydberg atom graph. The user can select the control functions Ω(t) and Δ(t) are selected considering the boundary conditions of the initial Hamiltonian and the final problem Hamiltonian. Then the dynamic evolution starts from the initial state |ψ(0) [symbol] and through a series of time-dependent processes, the system continues the time evolution. At this step, (i) the adiabatic process is chosen so that the system will be under the control of Ω(t) and Δ(t). Since the dynamic system is commonly hard to be adiabatic, alternatively, (ii) Floquet-ACQC is used where a Floquet Hamiltonian is implemented to realize the combination of adiabatic Hamiltonian and CD terms in a way so that the system has a higher probability to reach the target state at the final time than the adiabatic process. At the end of the time evolution, a measurement is performed to obtain bit string counts or fidelity as the output.

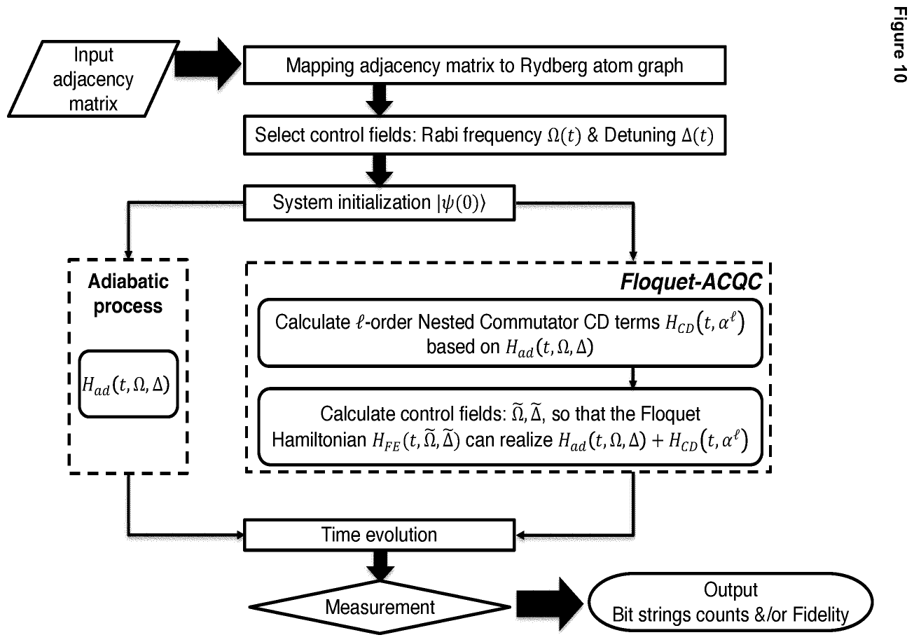

FIG. 11: Apparatus (100) for performing a method for solving a combinatorial optimization problem involving analog counterdiabatic quantum computing (ACQC)

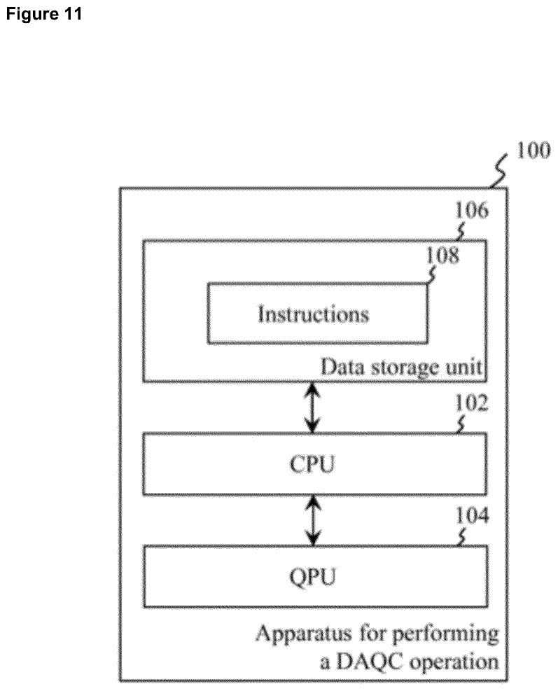

As shown in FIG. 11, the apparatus 100 comprises a central processing unit (CPU) 102, a quantum processing unit (QPU) 104, and a data storage unit 106. The QPU 104 is connected to the CPU 102. The data storage unit 106 is connected to the CPU 102 and stores processor-executable instructions 108. Being executed by the CPU 102, the processor-executable instructions 108 cause the CPU 102 to implement the aspects of the present invention.

The number, arrangement, and interconnection of the constructive elements constituting the apparatus 100, which are shown in FIG. 11, are not intended to be any limitation of the present invention, but merely used to provide a general idea and example of how the constructive elements may be implemented within the apparatus 100. For example, each of the CPU 102 and the QPU 104 may be replaced with several corresponding processing units, as well as the data storage unit 106 may be replaced with several removable and/or fixed storage devices, depending on particular applications. Furthermore, the apparatus 100 may further comprise a transceiving unit (not shown) which, for example, may be configured to receive the processor-executable instructions 108 from a remote server and store them to the data storage unit 106 before the operation of the apparatus 100, as well as transmit the operation results of the apparatus 100 to the remote server.

The CPU 102 may be implemented as a general-purpose processor, single-purpose processor, microcontroller, microprocessor, application specific integrated circuit (ASIC), field programmable gate array (FPGA), digital signal processor (DSP), complex programmable logic device, or alike. The CPU 102 may be implemented as any combination of one or more of the aforesaid. As an example, the CPU 102 may be a combination of two or more microprocessors.

The QPU 104 may refer to a physical (fabricated) or simulated processor that contains a number of interconnected qubits. In this sense, the QPU 104 serves as a quantum information storage device. The QPU 104 may include a single quantum processor, or two or more quantum processors. The QPU 104 may be based on a couple of Rydberg atoms held by optical tweezers in vacuum, or based on a 2D grid of transmon qubits on a chip. The QPU 104 may also take the form of a superconducting quantum processor. The superconducting quantum processor may include multiple qubits and a plurality of superconducting coupling devices operable to selectively connect the qubits in pairs and couple the pairs therebetween. Examples of the superconducting coupling device may include radio frequency superconducting quantum interference devices (rf-SQUIDs) and direct current SQUIDs (dc-SQUIDs), which couple the qubits together by magnetic flux.

Alternatively, charge-based coupling devices may be used in the QPU 104.

The data storage unit 106 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Bluray discs), etc. As for the volatile memory, examples include Dynamic RAM, Synchronous DRAM (SDRAM), Double Data Rate SDRAM (DDR SDRAM), Static RAM, etc.

The processor-executable instructions 108 stored in the data storage unit 106 may be configured as a computer-executable code which causes the CPU 102 to implement the aspects of the present invention. The computer-executable code for carrying out operations or steps for the aspects of the present invention may be written in any combination of one or more programming languages, such as Java, C++, or the like. In some examples, the computer-executable code may be in the form of a high-level language or in a pre-compiled form and be generated by an interpreter (also pre-stored in the data storage unit 106).

### EXAMPLES

Exemplary embodiments of the invention will now be discussed in further detail. This invention may, however, be embodied in many different forms and should not be construed as limited to the embodiments set forth herein.

### Rydberg Qubits

Neutral atoms set-ups have been used for years as a versatile experimental platform for quantum simulation. The shift in interest from quantum simulation to quantum computation with industrial applications in mind followed with the recent technological developments for trapping and manipulating arrays of single atoms led to the use of neutral atoms platforms to perform analog quantum computing. One of the most commonly used atomic species for quantum computation is rubidium-87 due to its very well-understood electronic structure as well as the availability of the lasers necessary to create a rubidium experiment.

A key element to realize quantum computation with neutral atoms is the use of Rydberg states. Rydberg states are electronic states of an atom which has high quantum number, thus where the outer shell electron is promoted far away from the atomic core. This yields long range interactions with neighboring atoms. There are different ways to exploit Rydberg states that yields different spin state mapping scheme for neutral atoms platforms.

Another key element is the use of optical tweezers which are far-off resonance laser beams used to trap single atoms in space and reorganize them into any 2-dimensional or 3-dimensional patterns. Cooled down atomic clouds, Rydberg states and optical tweezers constitutes the fundamental building blocks of the vast majority of neutral atoms quantum computation platforms.

A two spin states mapping scheme is described here as an example.

### Ground-Rydberg Mapping

An atom which outer shell electron is promoted to a Rydberg state will interact with a neighboring atom in its natural ground state through a Van der Waals interaction. This interaction creates the Rydberg blockade phenomenon which prevents two neighboring atoms to be excited both in the Rydberg state creating quantum logic which is exploited on neutral atoms platform to recreate an Ising Hamiltonian in Eq. (5).

This is achieved by shining lasers coupling through a two-photon transition the electronic ground state to the Rydberg state. Here, Ω is the Rabi frequency of the transition and can be dynamically controlled by controlling the power of one of the coupling lasers, Δ corresponds to the detuning with regards to the two-photon transition and can also be changed dynamically.

The term containing J is the interactions term implemented via the Rydberg blockade mechanism and decays with the distance between the two interacting atoms. It can be rendered site-dependent as well as can be dynamically tuned to a certain extent.

This is the most common spin state mapping scheme used by neutral atoms hardware companies as it is one of the easiest to implement experimentally and control and because of the shape of the native Ising Hamiltonian onto which many industry-relevant problems can be encoded.

### Rydberg-Rydberg Mapping

Another spin state mapping scheme relies on the use of two different Rydberg states of the same atomic species. Two neighboring atoms cannot be promoted into the same Rydberg state but can be promoted to different Rydberg states. The two far-away outer shell electrons will then interact through dipole-dipole interaction which decays with the distance between the two atoms with a different power law than the Van der Walls interaction described in the previous subsection. By mapping the spin states of the qubits onto both Rydberg states, the resulting Hamiltonian is then written as:

$${H}_{rr} = {\sum }_{i < j} {V}_{i , j} ( {σ}_{i}^{x} {σ}_{j}^{x} + {σ}_{i}^{y} {σ}_{j}^{y} ) \qquad ( 9 )$$

with σ^{x} and σ^{y} the spin states Pauli matrices and Vᵢⱼ the interaction coefficient introduced when a microwave field is turned on to couple the two Rydberg states. This Hamiltonian has the shape of a Heisenberg Hamiltonian.

### Neutral Atoms Computation

Current neutral atoms quantum computers using the Ground-Rydberg (G-R) mapping show results of computing with a typical number of qubits ranging from 200 to 400 qubits. The number of qubits may soon be increased to 1000. Those computations are performed in the framework of adiabatic computation; the next section will give context for this framework.

The main limitations of the G-R mapping are the lifetime of the Rydberg state used as one of the spin states which is approximately 30 μs. This time is not enough to be able to perform a real adiabatic computation and results in a lot of noise in the results. As for other platforms, the way to allow those computation to find the solutions is through variational methods and a high number of repetitions of the experiment to get the solution statistically.

One example of such methods to compute the solution of the maximum independent set problems, a combinatorial optimization problem which shape is ideal to benchmark neutral atoms quantum computers against, is presented here.

The results of the computation of the MIS problem on a Ground-Rydberg mapped neutral atoms computers with up to 289 qubits has been shown. To improve the results limited by the coherence time, they leverage two variational methods commonly used in quantum computing problems, the quantum approximate optimization algorithm (QAOA) and variational quantum adiabatic algorithm (VQAA). The first method, QAOA, is used to parametrize a series of resonant laser pulses, coupling the two spin states, which effectively realizes the evolution of the many-body Hamiltonian. By finding variationally an optimal ensemble of parameters for those pulses, the probability of reaching the desired state corresponding to the solution of the problem was enhanced. For the second method, VQAA, the continuous function controlling the dynamically tunable parameters of the Hamiltonian was split into a segment that are variationally optimized to increase the probability of finding the desired state corresponding to the solution of the problem.

The results obtained constitute one of the best promising results for quantum computation with neutral atoms, but the methods used are at the current time limited by the available coherence time of the qubits. Additionally, with the increase of the system size the variational part of the algorithm becomes extremely time costly.

The method of the invention solves problems with a higher number of qubits and circumvents the limitation of the coherence time by reducing the computation time for each repetition.

### Mapping and Adiabatic Framework

The framework used to compute problems onto an analog quantum computer is the adiabatic framework and quantum annealing. For adiabatic quantum computing, one starts from a Hamiltonian which has a trivial ground state and evolves the system towards a Hamiltonian which has the solution of the computation problem as its ground state. The evolution should be adiabatic which yields very long computation times. This is limited by the coherence time of the system which does not allow complete adiabatic evolution. In the case of neutral hardware, the computation of combinatorial optimization can only be done with a non-adiabatic evolution between the initial Hamiltonian and the problem (the final) Hamiltonian. This leads to possible excitations in the energy spectrum and can yield the wrong final state, in other words the wrong solution of the problem. To circumvent that one can try optimizing the time dependent function with which the system changes from the initial Hamiltonian to the problem Hamiltonian. This function is called the scheduling function.

### Introducing a Counterdiabatic Protocol

Counterdiabatic (CD) protocols aim to prevent transitions while speeding up the adiabatic quantum computation, thus allowing for good results for systems where the adiabatic time is long in regards with the coherent time of the system or the experimentally available time of computation. This stems from adding an effective gauge potential that will counter the excitations due to the non-adiabatic time.

One way to recreate an approximate gauge potential is by using a nested commutator CD term. This improves the results of computation for short time allowing the system to find the right solution statistically. The downside is the difficulty of its implementation on neutral atom systems as it requires the addition of interactions in the system which are not native.

According to one aspect of the invention, this nested commutator CD term is implemented on a typical neutral atom hardware using Floquet engineering. Another possibility to implement CD protocols is to use a one-body local CD term which is an approximation of the first order nested commutator CD term. This is easier to natively implement it; in one aspect of the invention is implemented via a rotation of the system without requiring the addition of non-native coupling or free energies.

Realizing Nested commutator CD terms through Floquet engineering: Floquet Analog Counterdiabatic Quantum Computing method (F-ACQC)

Floquet engineering is the concept of modifying a system through periodic driving. This driving can be used, for example, to modify, beyond what is natively possible, the parameters of the system or to explore new phases without static counterpart. The seminal classical equivalent is the Kapitza pendulum, whereby shaking the whole system periodically the system can achieve equilibrium with the pendulum standing upright. Floquet engineering has been used in neutral atoms experiments extensively in the context of the study of Bose-Einstein condensate in optical lattices to study new phases in the Bose-Hubbard model.

One application of Floquet engineering is to create an effective gauge potential in the system. Floquet engineering can be used to create the effective gauge potential of the nested commutator counterdiabatic protocol. This periodic driving of the system does not require the addition of non-native interaction terms in the system which are typically difficult to implement on neutral atoms hardware.

The Hamiltonian of neutral atoms platforms using Ground-Rydberg mapping in Eq. (5) can also read:

$${H}_{Ryd} ( t ) = {H}_{drive} + {H}_{int} , \qquad ( 10 )$$

where

$${H}_{drive} ( t ) = Ω ( t ) {\sum }_{i} {σ}_{i}^{x} - Δ ( t ) {\sum }_{i} {n}_{i} and {H}_{i n t} ( t ) = {\sum }_{i < j} {J}_{i , j} {n}_{i} {n}_{j} .$$

The target ground state of final Hamiltonian encodes the solution to the computation problem, which provides the final constraints for the driving field.

Adiabatic computing is a known tool to solve optimization problems whose solutions are encoded to be the ground state of the problem Hamiltonian (the adiabatic Hamiltonian at the final time of computation) H_{Ryd}(T)=Hₚ. By choosing an initial Hamiltonian (the adiabatic Hamiltonian at the initial time of computation) H_{Ryd}(0) for which the corresponding ground state is known, the adiabatic process can ensure that one evolves the system from initial H(0) to the final H(T) by slowly changing the driving variables while fulfilling the boundary conditions for t=0 and t=T, which means that the wave function of the system |ψ(t) [symbol] follows the instantaneous eigenstates of Hamiltonian |n(t) [symbol] , so that the final state of the system is the target ground state of the problem Hamiltonian Hₚ.

Then, following the typical counterdiabatic (CD) approach, an additional CD term H_{CD} is added to the Rydberg Hamiltonian to reach the target in a shorter time or for the same computational time obtain higher fidelity. Therefore, the total Hamiltonian of the system is

$$H ( t ) = {H}_{Ryd} + {H}_{C D} \qquad ( 11 )$$

For example, this step of the method can be used to solve combinatorial optimization problems on a neutral atoms platform, such as a Maximal independent set (MIS). MIS is a combinatorial optimization problem consisting of a graph of vertices connected by edges and for which the solution is the graph containing the maximum number of colored vertices without having two colored vertices connected by an edge.

In the following, two exemplary CD protocols are provided depending on the capability of the hardware, and a MIS problem is used as a benchmark example.

### A. Nested Commutator CD Protocol Through a Floquet Engineering Protocol

Using the nested commutator CD method for speeding up adiabatic Hamiltonian, the following approach is used to adapt for current neutral atoms system which has more than one control variables H_{Ryd}(Ω, Δ) as shown in Eq. (5). Then, the total Hamiltonian H(t)=H_{Ryd}+H_{CD} IS obtained by adding the [symbol] -th order nested commutator CD terms H_{CD} which is calculated to be the approximated adiabatic gauge potential where H_{CD} can be written as

$${H}_{C D}^{( ℓ )} = i {\sum }_{k = 1}^{ℓ} {α}_{k} ( t ) {\underbrace{[ {H}_{Ryd} , [ {H}_{Ryd} , … [ {H}_{Ryd} , M ] ] ]}}_{2 k - 1} , \qquad ( 12 )$$

where M=Ω∂_{Ω}H_{Ryd}+Δ∂_{Δ}H_{Ryd}, and time-dependent parameters αₖ(t) are solved to minimize the action

$${S}_{ℓ} = T r [ {G}_{ℓ}^{2} ]$$

$${G}_{ℓ} = M - i [ H , {H}_{CD}^{( ℓ )} ] . \qquad ( 13 )$$

Although the nested commutator CD protocol can improve the results of adiabatic computation for shorter times even in comparison with other optimization methods (such as QAOA, VQE etc.), the complexity of the corresponding additional terms can make it difficult to implement on an analog system.

One embodiment of the invention uses Digital Analog Quantum Computing. However, it relies strongly on the future compatibility of the hardware.

Another way to realize the nested commutator CD protocol is through Floquet engineering. Although the driving will reveal itself to be non-trivial, instead of requiring implementing experimentally the many-body interacting terms, such as

$${σ}_{i}^{z} {σ}_{j}^{y}$$

which typically appears in the nested commutator CD terms, it represents an easier challenge which is to drive periodically the Hamiltonian system.

A practical method based on current neutral atoms hardware is provided to effectively implement this nested commutator CD protocol.

The results could serve as a benchmark of the implementation of CD protocols on neutral atoms hardware and could open up the field of development of those techniques to potentially help towards quantum speed up. Considering the nested commutator CD in Eq. (8, 9), its Floquet Engineered driving equivalent may be calculated in the following manner.

Following the known Floquet theory, Floquet Hamiltonian with high frequency oscillation can be written as

$${H}_{F} ( t ) = [ 1 + \frac{ω}{{ω}_{0}} cos ( ω t ) ] {H}_{Ryd} + β ( t ) M , \qquad ( 14 )$$

wherein β(t) are Floquet-variables and

$$β ( t ) = {\sum }_{k = 1}^{∞} {β}_{k} sin ( ( 2 k - 1 ) ω t ) and , \qquad ( 15 )$$

$$M = Ω {\partial }_{Ω} {H}_{Ryd} + Δ {\partial }_{Δ} {H}_{Ryd} = {\partial }_{t} {H}_{Ryd} . \qquad ( 16 )$$

Consider the dominant contribution to the Magnus expansion of the time-averaged Hamiltonian

$${H}_{F}^{( 0 )} ,$$

the off-diagonal elements of the eigenstates of H_{Ryd} can be calculated as

$$〈 m \vert {H}_{F}^{( 0 )} \vert n 〉 = i {\sum }_{k = 1}^{∞} {β}_{k} {J}_{2 k - 1} ( \frac{{ϵ}_{m} - {ϵ}_{n}}{{ω}_{0}} ) 〈 m \vert M \vert n 〉 , \qquad ( 17 )$$

where |n [symbol] and ϵₙ are the eigenstates and energy spectrum of the Hamiltonian, which means that H_{Ryd}|n [symbol] =ϵₙ|n [symbol] . Then applying the Taylor expansion around zero for the Bessel functions of the first kind Jₖ which satisfies Jₖ((ϵₘ−ϵₙ)/ω₀)∝(ϵₘ−ϵₙ)^{k} for a small value of (ϵₘ−ϵₙ)/ω₀, the Floquet Hamiltonian followed the driving Hamiltonian in Eq. (11) can be rewritten as

$${\tilde{H}}_{F} = {H}_{Ryd} + i {\sum }_{k = 1}^{∞} {β}_{k} {\sum }_{m = 0}^{∞} \frac{{( - 1 )}^{m} {( 2 {ω}_{0} )}^{1 - 2 k - 2 m}}{m ! ( 2 k + m - 1 ) !} \times {\underbrace{[ {H}_{Ryd} , [ {H}_{Ryd} , … [ {H}_{Ryd} , M ] ] ]}}_{2 k + 2 m - 1} . \qquad ( 18 )$$

As an example, one can prove that

$${\tilde{H}}_{F}^{( 1 )} = {H}_{Ryd} + i \frac{{β}_{1}}{2 {ω}_{0}} [ {H}_{Ryd} , M ] , \qquad ( 19 , 20 )$$

$${\tilde{H}}_{F}^{( 2 )} = {\tilde{H}}_{F}^{( 1 )} + \frac{{β}_{2} - 3 {β}_{1}}{48 {ω}_{0}^{3}} [ {H}_{Ryd} , [ {H}_{Ryd} , M ] ] ] .$$

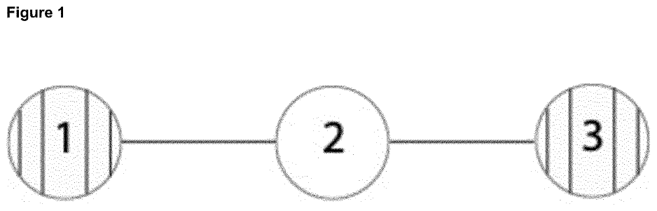

To satisfy that \tilde{H}_{FE} becomes the effective combination of Rydberg Hamiltonian and its nested commutator CD Hamiltonian in Eq. (8, 9), the Fourier coefficients βₖ can be solved as the following examples (see FIG. 1):

$${β}_{1} = 2 {ω}_{0} {α}_{1} , \qquad ( 21 , 22 )$$

$${β}_{2} = 2 {ω}_{0} ( 24 {ω}_{0}^{2} {α}_{2} + 3 {α}_{1} ) .$$

Combining the Floquet Hamiltonian in Eq. (11), the Floquet-ACQC control field of Rydberg Hamiltonian in Eq. (5) for the example of the 1st order [symbol] =1 in Eq. (9) becomes

$$\tilde{Ω} ( t ) = [ 1 + \frac{ω}{{ω}_{0}} cos ( ω t ) ] Ω ( t ) + {β}_{1} ( t ) sin ( ω t ) {\partial }_{t} Ω ( t ) , \qquad ( 23 )$$

$$\tilde{Δ} ( t ) = [ 1 + \frac{ω}{{ω}_{0}} cos ( ω t ) ] Δ ( t ) + {β}_{1} ( t ) sin ( ω t ) {\partial }_{t} Δ ( t ) , \qquad ( 24 )$$

$$\tilde{J} ( t ) = [ 1 + \frac{ω}{{ω}_{0}} cos ( ω t ) ] . \qquad ( 25 )$$

Consider the current neutral atoms hardware limitation, the two-body interaction terms cannot be a time-dependent control, therefore, Eq. (21) is modified to be

$$\tilde{J} ( t ) = J . \qquad ( 26 )$$

There are different ways to choose control fields (Ω(t) and Δ(t)) so that the total control of Rydberg Hamiltonian (\tilde{Ω}(t), \tilde{Δ}(t)) which is our Floquet-engineering Nested commutator CD method can solve these optimization problems faster with higher success probability. The success probability is the probability of obtaining the ground state of the final Hamiltonian encoding the solution of the problem with a single computation.

### B. One-Body CD Term Protocol

To circumvent the complexity of the additional two or more body interacting terms because of the limitation of experiment implementation, the simple one-body CD form of N-qubit system is

$${H}_{CD} = ( \dot{Ω} + \dot{Δ} ) {A}^{y} , wherein \qquad ( 27 )$$

$${A}^{y} = {\sum }_{i = 1}^{N} {α}_{i}^{y} ( t ) {σ}_{i}^{y} \qquad ( 28 )$$

with local coefficients

$${α}_{i}^{y} ( t )$$

which can solved by being the solution to minimize the action of S as follows

$$S = Tr [ {G}^{2} ] wherein \qquad ( 29 )$$

$$G = M - i ( \dot{Ω} + \dot{Δ} ) [ H , {A}^{y} ] , \qquad ( 30 )$$

where M=Ω∂₁₀₆ H_{Ryd}+Δ∂_{Δ}H_{Ryd}, i is the imaginary unit and the dot represents the derivative with respect to time.

The results can be further improved by adding a layer of optimization on the scheduling function (optimal control theory, variational protocols).

Moreover, if the σ^{y} term is limited by experiment which means that only one global control variable

$${α}_{i}^{y} ( t ) = {α}^{y}$$

for different

$${σ}_{i}^{y}$$

terms are realizable in experiment platform, then this one-body term is considered to provide a valid improvement for a short computation time.

Certainly, if the local control is realizable experimentally, one can also push further by implementing different local parameters

$${σ}_{i}^{y}$$

terms for each qubit that will further enhance the results.

The one-body CD protocols yield a significant improvement of the results for time shorter than adiabaticity. Although this additional term might still be non-trivial to implement on the experimental system, with a simple rotation of the spin axes along the z axis in the Ising model framework such as:

$$U ( t ) = exp ( - \frac{i}{2} {\sum }_{j = 1} {θ}_{j} ( t ) {σ}_{j}^{z} ) , \qquad ( 31 )$$

one ends up with a Hamiltonian with non-trivial time dependent coefficient for the Rabi frequency and the detuning of the coupling field. It is noted that the CD term appears as part of the time dependent coefficient of the time dependent terms but there is no added term in this form, i.e. σ^{y} term.

### Data Obtained

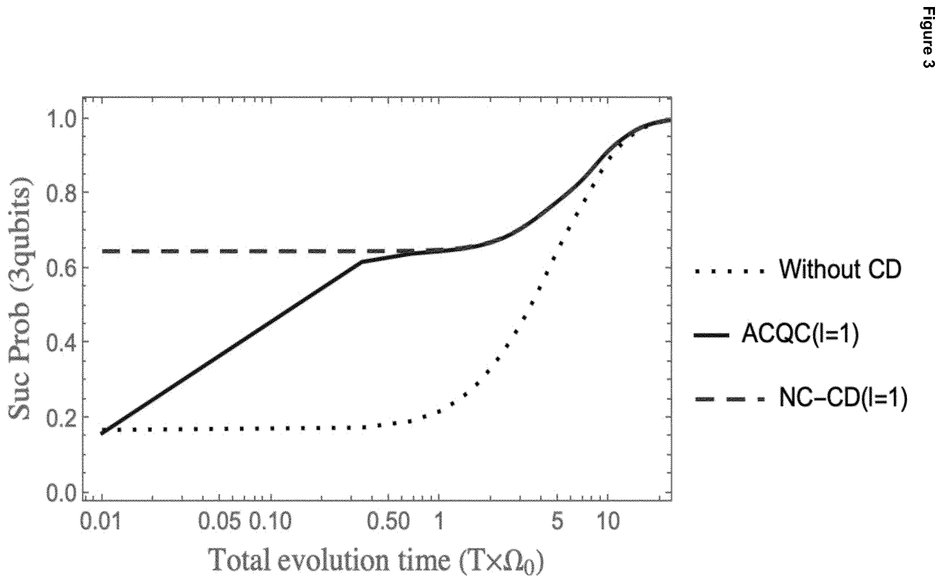

Examples of combinatorial optimization problems, in particular the Maximal independent set (MIS) combinatorial optimization problems of an N-atoms system are shown in the figures. Simple toy models of 3 and 7 qubits systems are used, see FIGS. 1 and 3. There are a family of scheduling functions in Eq. (19-20) that can be chosen with the constrains depending on the hardware limitation.

1. First, one example is shown of scheduling functions to solve a 3 qubits problem as follows.

By applying a CD protocol for the following form of adiabatic Hamiltonian Hₐ(t)=(1−λ(t))Hᵢ+λ(t)Hₚ, the ansatz of the control variables is provided as

$$Ω ( t ) = {Ω}_{0} ( 1 - λ ( t ) ) , and Δ ( t ) = {Δ}_{0} λ ( t ) , \qquad ( 32 )$$

where Ω₀ and Δ₀ are the maximum value of the experimental Rabi frequency and the detuning respectively. Then the Rydberg Hamiltonian in Eq. (5) becomes

$${H}_{Ryd} = {Ω}_{0} ( 1 - λ ( t ) ) {\sum }_{i} {σ}_{i}^{x} - {Δ}_{0} λ ( t ) {\sum }_{i} {n}_{i} + J ( {n}_{1} {n}_{2} + {n}_{2} {n}_{3} ) , \qquad ( 33 )$$

where λ is a time-dependent scheduling function which fulfills the boundary conditions λ(0)=0 and λ(T)=1. In this case, the initial state for one to prepare should be the ground state of

$${H}_{Ryd} ( 0 ) = {Ω}_{0} {\sum }_{i} {σ}_{i}^{x} + J ( {n}_{1} {n}_{2} + {n}_{2} {n}_{3} ) .$$

The initial ground state can be solved numerically, for example, J=4, |ψ(0) [symbol] =|−0.5231631732824501, 0.45105747137515934, 0.33446499190807844, −0.1336991966412011, 0.45105747137515934, −0.40928419192378085, −0.1336991966412011, 0.06529378391970472 [symbol] in the basis of bit string. To guarantee the ground state of the final Hamiltonian H_{Ryd}(T) being the MIS solution, the constraint of parameters in this embodiment is Δ₀<2J.

Taking the following example of the scheduling function

$$λ ( t ) = {sin}^{2} [ \frac{π}{2} {sin}^{2} ( \frac{π t}{2 T} ) ] , \qquad ( 34 )$$

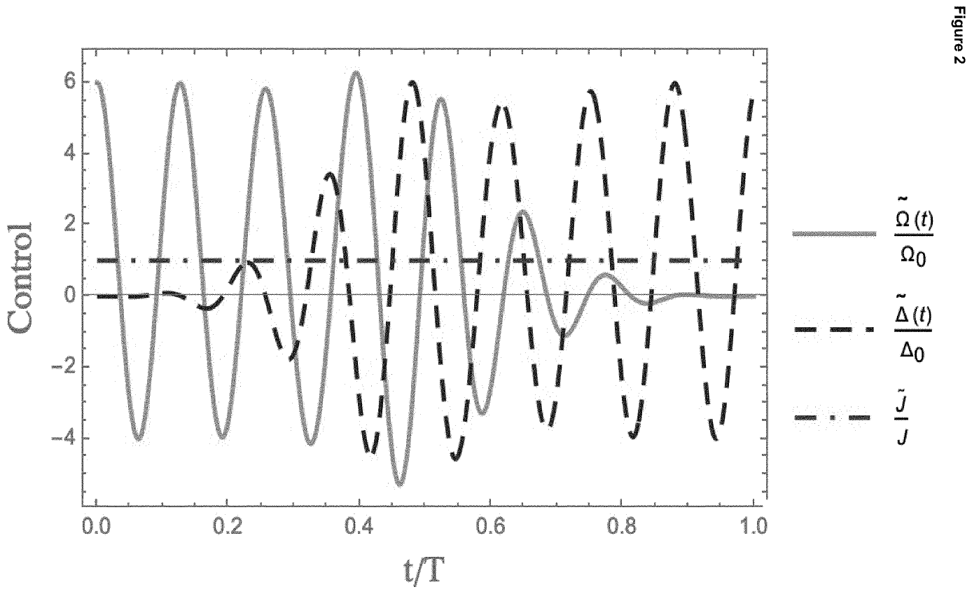

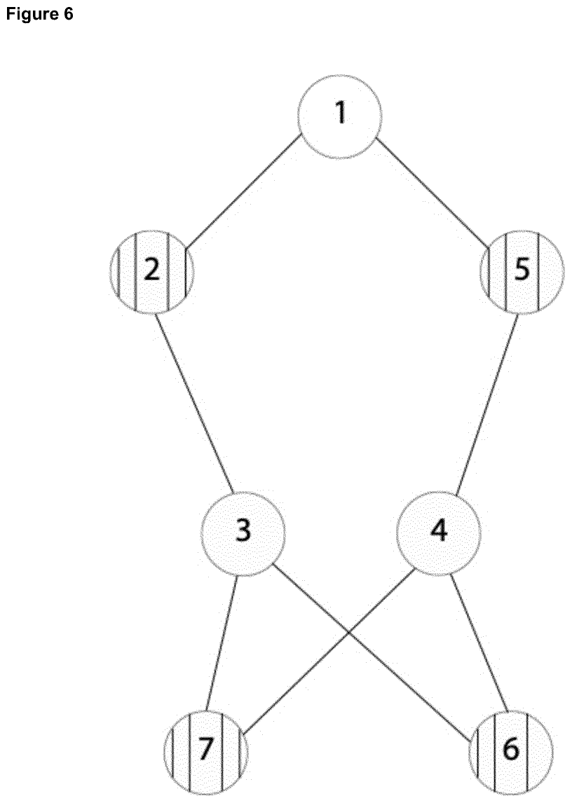

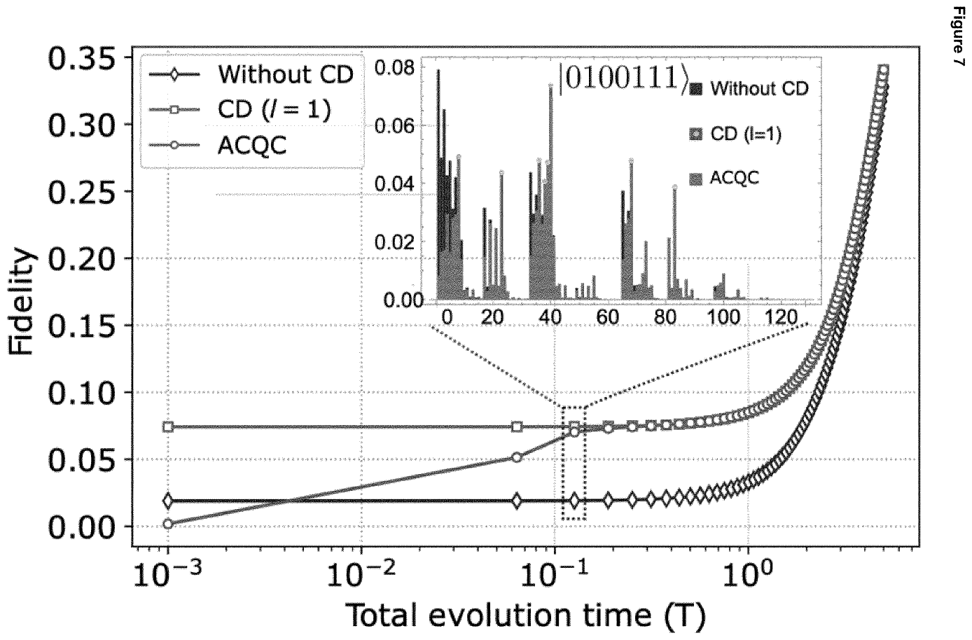

the total control functions (\tilde{Ω}(t), \tilde{Δ}(t)) in Eq. (19-22) are plotted in FIG. 2. FIG. 3 shows the success probability for different evolution time T in the case of a time-dependent interaction in Eq. (21) where the solid line shows enhancement of F-ACQC method in the case of the initial state of the system is a superposition state. Another example for a 7-atoms graph in FIG. 6 is shown in FIG. 7. As an example of a time-dependent interaction in Eq. (21), the F-ACQC method can mimic a nested commutator CD protocol after a certain total evolution time T and F-ACQC can reach the target faster than without a CD protocol. The insert plot in FIG. 7 shows an example for a small value of evolution time T where F-ACQC provides the most populated state to be the MIS solution, however, without CD protocol this is not the case.

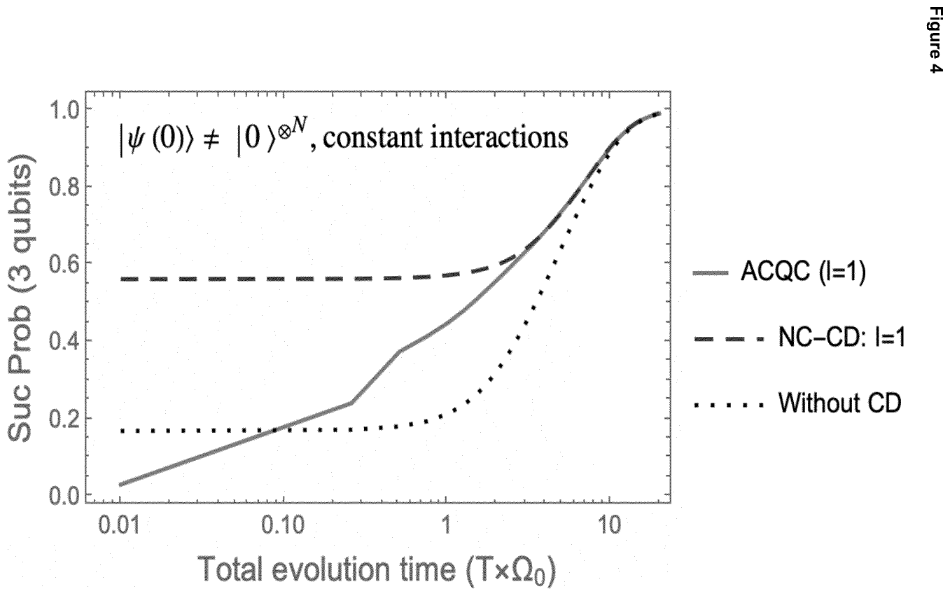

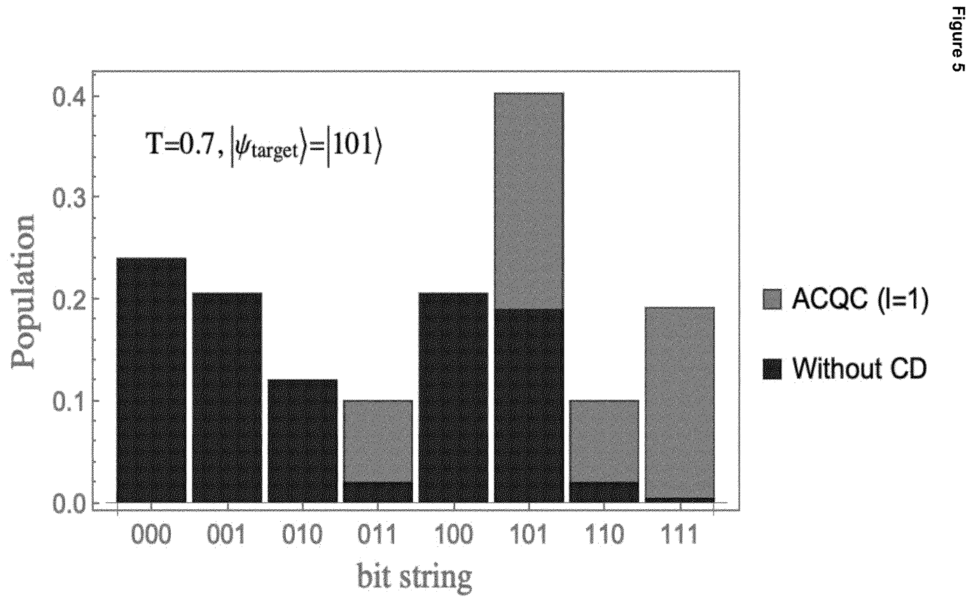

In another case of a constant interaction terms in Eq. (22), the results of ACQC are shown in FIG. 4. Following this constant interaction terms case, the population at the final time (T) is shown as an instance in FIG. 5 where one can see the enhancement by using the F-ACQC method. Without CD terms, at the final time the most populated state is not the target, however, the F-ACQC method result can reach the MIS solution |101 [symbol] .

2. In the case where all the neutral atoms stay in their ground state |0 [symbol] , one way to solve the graph problem is to combine the case 1. above and prepare another process for which the initial state of the system is |0 [symbol] (with N i being the number of qubits) and the state reaches a superposition state which is the ground state of

$${H}_{Ryd} ( 0 ) = {Ω}_{0} {\sum }_{i} {σ}_{i}^{x} + J ( {n}_{1} {n}_{2} + {n}_{2} {n}_{3} ) .$$

Then the system follows the protocol of case 1 to reach the target state.

3. For the case where all the neutral atoms stay in their ground state |0 [symbol] , another method is to fulfill the following boundary conditions of the control fields:

$$Ω ( 0 ) = Ω ( T ) = 0 , \qquad ( 35 )$$

$$Δ ( 0 ) = - {Δ}_{0} , Δ ( T ) = {Δ}_{0} , \qquad ( 36 )$$

Therefore, the initial ground state of Rydberg Hamiltonian H_{Ryd}(0) in Eq. (5) is |0 [symbol] (N is the number of qubits).

One example of a set of scheduling functions which satisfies the boundary conditions in Eq. (27, 28) is

$$Ω ( t ) = {Ω}_{0} {sin}^{2} [ \frac{π}{2} {sin}^{2} [ \frac{π}{2} {sin}^{2} ( \frac{π t}{T} ) ] ] , \qquad ( 37 )$$

$$Δ ( t ) = {Δ}_{0} tanh [ 9 Tan [ \frac{π}{2} ( \frac{t}{T} - \frac{1}{2} ) ] ] . \qquad ( 38 )$$

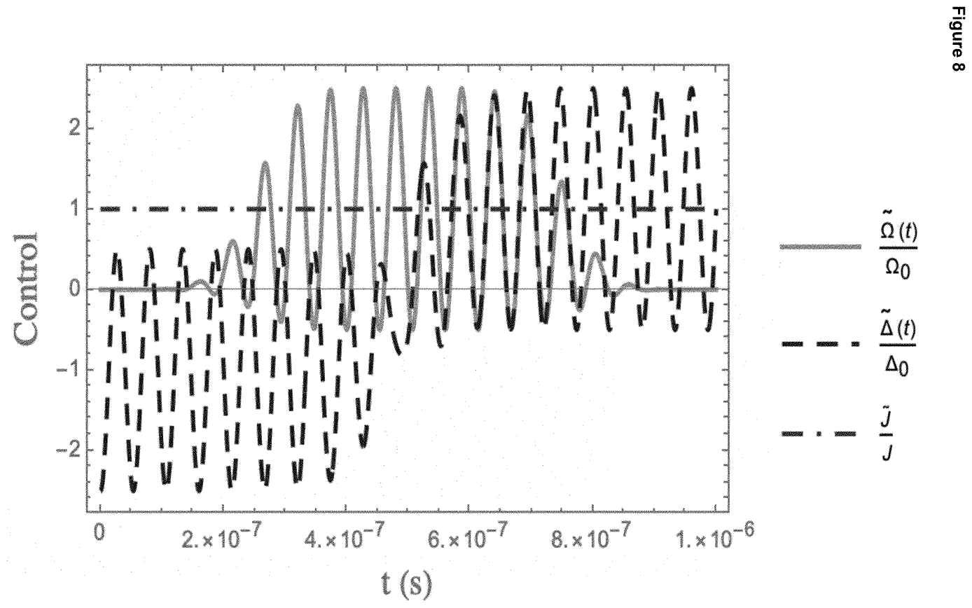

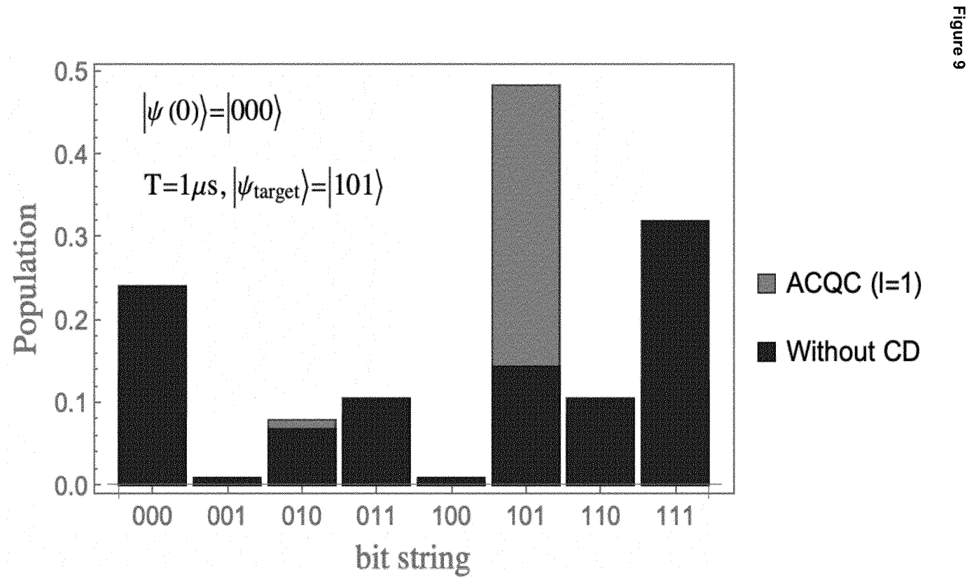

An example of these time-dependent control functions is shown in FIG. 8 and the corresponding results of a constant interactions case in Eq. (22) of a 3-qubit graph problem in FIG. 1 is shown in FIG. 9.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A computer-implemented method for solving a combinatorial optimization problem using an analog quantum computer with a quantum processing unit, comprising:
Providing to the quantum processing unit of the analog quantum computer a time-dependent adiabatic Hamiltonian,
wherein the time-dependent adiabatic Hamiltonian contains a set of continuous quantum variables which are controllable on the analog quantum computer, and
wherein a ground state of the time-dependent adiabatic Hamiltonian at a final evolution time encodes a solution to the combinatorial optimization problem;
Calculating nested commutator counterdiabatic terms as being an approximate adiabatic gauge potential of the time-dependent adiabatic Hamiltonian,
wherein the nested commutator counterdiabatic terms comprise quantum Pauli X-operators, Y-operators, and Z-operators and commutator counterdiabatic coefficients of the X-, the Y- and the Z-operators;
Replacing the adiabatic Hamiltonian by a Floquet-Hamiltonian comprising a set of continuous quantum Floquet-variables;
Implementing the set of continuous quantum Floquet-variables on the quantum processing unit of the analog quantum computer so that the analog quantum computer evolves with time in a counterdiabatic manner to reach the ground state of the Floquet-Hamiltonian;
Measuring a quantum state of the analog quantum computer at the final evolution time to obtain a read-out of a quantum system; and
Determining the solution to the combinatorial optimization problem from the read-out.

2. The computer-implemented method of claim 1, wherein the set of continuous quantum Floquet-variables is calculated by using a Floquet engineering method.

3. The computer-implemented method of claim 1, wherein the Floquet-Hamiltonian is an approximation of a summation of the time-dependent adiabatic Hamiltonian and the nested commutator counterdiabatic terms.

4. The computer-implemented method of claim 2, wherein the evolution of the time-dependent Floquet-Hamiltonian from its initial computation time to a final computation time is performed using the Floquet engineering method to modulate a time dependent scheduling function.

5. The computer-implemented method of claim 4, wherein the modulation comprises at least one nested commutator counterdiabatic coefficient as part of a nested commutator counterdiabatic term.

6. The computer-implemented method of claim 1, wherein the nested commutator counterdiabatic term is
$${H}_{C D}^{( ℓ )} = i {\sum }_{k = 1}^{ℓ} {α}_{k} ( t ) {\underbrace{[ {H}_{a d} , [ {H}_{a d} , … [ {H}_{a d} , {\partial }_{t} {H}_{a d} ] ] ]}}_{2 k - 1}$$
wherein H_{ad} is the time-dependent adiabatic Hamiltonian, αₖ(t) is a nested commutator counterdiabatic coefficient.

7. The computer-implemented method of claim 1, wherein, if the analog quantum computer uses Ground-Rydberg atoms, the time-dependent adiabatic Hamiltonian is an Ising Hamiltonian of the form
$${H}_{R y d} = Ω ( t ) {\sum }_{i} {σ}_{i}^{x} - Δ ( t ) {\sum }_{i} {n}_{i} + J {\sum }_{i j} {n}_{i} {n}_{j}$$
wherein
$${n}_{i} = \frac{( 1 - {σ}_{i}^{z} )}{2} ,$$
wherein
$${σ}_{i}^{z}$$
is the Pauli Z matrix,
Ω is the Rabi frequency which describes the rate at which qubits transition between their two states when driven by an external oscillating field generated by a coupling laser, and is dynamically controlled by controlling the power of a coupling laser,
Δ corresponds to a detuning which represents an energy difference between the two states of the qubit with regards to a two-photon transition and is changed dynamically, and
the term containing J is the interactions term defined by a Rydberg blockade mechanism and is site-dependent or dynamically tuned.

8. The computer-implemented method of claim 1, wherein if the analog quantum computer uses trapped ions, the time-dependent adiabatic Hamiltonian is
$${H}_{i o n s} ( t ) = {\sum }_{i} \frac{{Ω}_{i}}{2} ( {σ}_{i}^{x} cos {θ}_{i} + {σ}_{i}^{y} sin {θ}_{i} ) + {\sum }_{i < j} {J}_{i , j} {σ}_{i}^{x} {σ}_{j}^{x} ,$$
wherein Ωᵢ is resonant Raman Rabi frequency on ion i, θᵢ is angle of spin i in the xy plane of the Bloch sphere about the precession of an effective transverse magnetic field, and wherein they can be modulated through a coupling laser,
J_{i,j} is the effective spin-spin coupling strength between an ion I and an ion j which is defined as
$${J}_{i j} = {Ω}_{i} {Ω}_{j} {\sum }_{m} \frac{{η}_{i m} {η}_{j m}}{{δ}^{2} - {ω}_{m}^{2}} {ω}_{m}$$
wherein Ωᵢ are Rabi frequencies, δ is bichromatic detuning and ωₘ is mode frequency.

9. The computer-implemented method of claim 1, wherein the computation time is limited by a coherence time of the quantum system.

10. A data processing apparatus comprising means for carrying out the computer-implemented method of claim 1.

11. The data processing apparatus in the form of an analog quantum computer, on which the computer-implemented method of claim 1 is implemented.

12. A computer program product comprising instructions which, when the program is executed by a computer, cause the computer to carry out the computer-implemented method of claim 1.

13. A computer-readable storage medium comprising instructions which, when executed by a computer, cause the computer to carry out the computer-implemented method of claim 1.

14. The computer-implemented method of claim 2, wherein the Floquet engineering method comprises:
manipulating the time-dependent Floquet-Hamiltonian by applying a periodic driving forces protocol with a sinusoidal function to create a periodic modulation of the time-dependent Hamiltonian which evolves the quantum system dynamically with time,
decomposing the sinusoidal function into a sum of sine or cosine functions comprising time-dependent coefficients, wherein each sine or cosine function is multiplied by a time-dependent coefficient, and
solving the time-dependent coefficients of the sine or cosine functions by satisfying the periodic modulation of the time-dependent Hamiltonian being the effective combination of the adiabatic Hamiltonian and its nested commutator counterdiabatic Hamiltonian, wherein the coefficients are the Floquet-variables.

15. The computer-implemented method of claim 6, wherein H_{ad} is added into the quantum system by doing a summation of
$${H}_{a d} + {H}_{C D}^{( ℓ )}$$
to improve the adiabatic process using the Floquet engineering method to drive the analog quantum computer periodically, wherein the driving is described by
$${H}_{F} ( t ) = [ 1 + \frac{ω}{{ω}_{0}} cos ( ω t ) ] {H}_{a d} + β ( t ) {\partial }_{t} {H}_{a d} ,$$
wherein ω is the frequency of the periodic driving, ω₀ is a natural frequency of the quantum system and β(t) is a time-dependent Floquet-coefficient,
modulating a strength of a time derivative term of the adiabatic Hamiltonian in the periodic driving Hamiltonian H_{F}(t).

16. The computer-implemented method of claim 15, wherein the driving is calculated under the constraints of mimicking the nested commutator counterdiabatic Hamiltonian
$${H}_{F} ( t ) \approx {H}_{a d} + {H}_{C D}^{( ℓ )} .$$
